(19) United States
(12) Patent Application Publication
(10) Pub. No.: US 2022/0306137 A1
(43) Pub. Date: Sep. 29, 2022

(54) VEHICLE CONTROL SYSTEM

(71) Applicant: TOYOTA JIDOSHA KABUSHIKI KAISHA, Toyota-shi Aichi-ken (JP)

(72) Inventors: Shuhei Manabe, Toyota-shi Aichi-ken (JP); Masato Endo, Nagoya-shi Aichi-ken (JP)

(21) Appl. No.: 17/590,156

(22) Filed: Feb. 1, 2022

(30) Foreign Application Priority Data
Mar. 25, 2021 (JP) 2021-052401

(51) Int. Cl. B60W 50/12; B60W 50/14; B60W 40/105; B60W 40/06; B60W 10/04

(52) U.S. Cl. CPC B60W 50/12; B60W 50/14; B60W 40/105; B60W 40/06; B60W 10/04; B60W 2540/10; B60W 2555/60

(57) ABSTRACT

In a vehicle control system, a standard driving model of a vehicle is stored in a model storage unit. A risk level determination unit compares a driving operation by a driver with a normative driving operation output from the standard driving model and determines a risk level of the driving operation. An operation limiting unit inputs, to a drive unit, a drive signal adjusted based on the determination by the risk level determination unit on the risk level of the driving operation by the driver so as to limit driving of the drive unit.

### CROSS-REFERENCE TO RELATED APPLICATION

This application claims priority to Japanese Patent Application No. 2021-052401 filed on Mar. 25, 2021, incorporated herein by reference in its entirety.

### BACKGROUND

### 1. Technical Field

The present disclosure relates to a vehicle control system.

### 2. Description of Related Art

Japanese Unexamined Patent Application Publication No. 2008-107974 (JP 2008-107974 A) discloses a technique related to a driving operation correspondence device. In the driving operation correspondence device, when a driver engages in risky driving, a warning is issued to the driver. Then, the driver can be caused to place an importance on the warning by reducing occupant comfort of a vehicle or limiting the start-up of an engine in accordance with a risk level of driving.

### SUMMARY

However, in the above-mentioned related art, the driving operation correspondence device cannot be directly involved in driving of the vehicle. Therefore, it is conceivable that a function of the vehicle unrelated to traveling of the vehicle is impaired.

In consideration of the above fact, it is an object of the present disclosure to obtain a vehicle control system capable of suppressing a driver from engaging in risky driving by direct involvement in driving of the vehicle.

A vehicle control system according to the present disclosure indicated in a first aspect includes: an operation device that is able to control a drive unit of a vehicle by inputting an operation signal based on a driving operation of a driver to a drive control unit that drives the drive unit; a model storage unit that stores a standard driving model of the vehicle; a risk level determination unit that compares the driving operation with the standard driving model and determines a risk level of the driving operation; and an operation limiting unit that is able to limit driving of the drive unit by inputting a drive signal to the drive unit, the drive signal being adjusted based on the determination on the risk level by the risk level determination unit.

According to the present disclosure indicated in the first aspect, when the driver performs the driving operation with the operation device, the operation signal based on the driving operation is input to the drive control unit that controls the drive unit of the vehicle, whereby the drive unit is controlled.

When the driver engages in the risky driving, it is not desirable that the driving operation by the driver be directly reflected in traveling of the vehicle. In this regard, it is conceivable to adopt a system that issues a warning to the driver by reducing occupant comfort of the vehicle or restricting the start-up of the engine when the driver engages in the risky driving. However, in such a system, the functions irrelevant to traveling of the vehicle are impaired, and the system cannot be directly involved in driving of the vehicle. Therefore, in terms of ensuring the traveling safety of the vehicle, it is conceivable that the system does not work well.

Here, in the present disclosure, the standard driving model of the vehicle is stored in the model storage unit. The risk level determination unit compares the driving operation by the driver with the standard driving model and determines the risk level of the driving operation. Then, the operation limiting unit inputs, to the drive unit, the drive signal adjusted based on the determination by the risk level determination unit on the risk level of the driving operation by the driver so as to limit driving of the drive unit.

Therefore, in the present disclosure, when the driver engages in the risky driving, it is possible to limit that the driving operation by the driver is directly reflected in traveling of the vehicle.

In the vehicle control system according to the present disclosure indicated in a second aspect, in the disclosure indicated in the first aspect, the operation device includes an accelerator pedal; the drive unit includes a power unit; the risk level determination unit determines a driving speed risk level by comparing a speed of the vehicle with a legal speed; and the operation limiting unit sets a speed limit of the vehicle in accordance with the driving speed risk level and drives the power unit up to the speed limit in accordance with a depression amount of the accelerator pedal, and controls a drive amount of the power unit at the speed limit such that the speed of the vehicle does not exceed the speed limit even when the depression amount increases.

According to the present disclosure indicated in the second aspect, the power unit of the vehicle is controlled by inputting the operation signal based on the operation of the accelerator pedal by the driver to the drive control unit.

When the driver tends to drive the vehicle in excess of the legal speed, it is not desirable that the operation of the accelerator pedal by the driver be directly reflected in driving of the power unit of the vehicle.

Here, in the present disclosure, the risk level determination unit determines the driving speed risk level by comparing the speed of the vehicle with the legal speed. Then, the operation limiting unit sets the speed limit of the vehicle in accordance with the driving speed risk level. When the speed of the vehicle is a speed up to the speed limit, the operation limiting unit drives the power unit in accordance with the depression amount of the accelerator pedal. On the other hand, in a state where the speed of the vehicle is the speed limit, the operation limiting unit controls the drive amount of the power unit such that the speed of the vehicle does not exceed the speed limit even when the depression amount of the accelerator pedal increases. As a result, according to the present disclosure, the speed of the vehicle can be limited when the driver tends to drive the vehicle in excess of the legal speed.

In the vehicle control system according to the present disclosure indicated a third aspect, in the disclosure indicated in the second aspect, the risk level determination unit determines a reverse driving risk level in accordance with the number of times that the driving operation deviates from the standard driving model when the vehicle is traveling in reverse; and the operation limiting unit limits the drive amount of the power unit in accordance with the reverse driving risk level when the vehicle is traveling in reverse.

According to the present disclosure indicated in the third aspect, the risk level determination unit determines a reverse driving risk level in accordance with the number of times that the driving operation by the driver deviates from the standard driving model when the vehicle is traveling in reverse. Then, the operation limiting unit limits the drive amount of the power unit in accordance with the reverse driving risk level when the vehicle is traveling in reverse. Therefore, according to the present disclosure, when the driver who tends to perform the driving operation that deviates from the standard driving model when the vehicle is traveling in reverse performs the driving operation to cause the vehicle to travel in reverse, unnecessary acceleration of the vehicle can be limited.

The vehicle control system according to the present disclosure indicated in a fourth aspect, in the disclosure indicated in the third aspect, further includes a warning device that issues a warning to the driver when the reverse driving risk level reaches a predetermined risk level.

Further, according to the present disclosure indicated in the fourth aspect, the warning device issues a warning to the driver when the reverse driving risk level determined by the risk level determination unit reaches a predetermined risk level. Therefore, according to the present disclosure, the driver can be made to recognize that the driving operation by the driver when the vehicle is traveling in reverse deviates from the standard driving model and encourage the driver to improve the driving operation when the vehicle is traveling in reverse.

In the vehicle control system according to the present disclosure indicated in a fifth aspect, in the disclosure indicated in any one of the first to fourth aspects, the risk level determination unit determines a narrow road driving risk level of the driving operation on a narrow road; and the operation limiting unit limits traveling of the vehicle on the narrow road in accordance with the narrow road driving risk level.

According to the present disclosure indicated in the fifth aspect, the risk level determination unit compares the driving operation by the driver with the standard driving model and determines the narrow road driving risk level of the driving operation on a narrow road. Then, the operation limiting unit limits traveling of the vehicle on the narrow road in accordance with the narrow road driving risk level. Therefore, according to the present disclosure, it is possible to limit entry of the vehicle to a road that is difficult for the driver to drive with the driving skill of the driver.

In the vehicle control system according to the present disclosure indicated in a sixth aspect, in the disclosure indicated in the fifth aspect, the vehicle is equipped with a navigation device that is able to guide directions to a destination; and the risk level determination unit is able to limit display of the narrow road by the navigation device in accordance with the narrow road driving risk level.

According to the present disclosure indicated in the sixth aspect, the risk level determination unit limits display of narrow roads by the navigation device in accordance with the narrow road driving risk level. Therefore, it is possible to suppress setting of a narrow road that is difficult for the driver to drive with the driving skill of the driver in the directions to the destination guided by the navigation device.

As described above, the vehicle control system according to the present disclosure indicated in the first aspect has an effect that the driver can be suppressed from engaging in the risky driving by direct involvement in driving of the vehicle.

The vehicle control system according to the present disclosure indicated in the second aspect has an effect that unnecessary acceleration due to the driving operation by the driver can be suppressed.

The vehicle control system according to the present disclosure indicated in the third aspect has an effect that the influence of erroneous operation by the driver can be reduced when the vehicle is traveling in reverse.

The vehicle control system according to the present disclosure indicated in the fourth aspect has an effect that the influence of the erroneous operation by the driver can be further reduced when the vehicle is traveling in reverse.

The vehicle control system according to the present disclosure indicated in the fifth aspect has an effect that the driver can be caused to drive the vehicle on a road having a road width corresponding to the driving skill of the driver.

The vehicle control system according to the present disclosure indicated in the sixth aspect has an effect that the accuracy that the driver is caused to drive the vehicle on a road having a road width corresponding to the driving skill of the driver can be enhanced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a hardware configuration of a vehicle in a vehicle control system according to the present embodiment;

FIG. 2 is a functional block diagram showing a configuration of a vehicle control system according to the present embodiment;

FIG. 3 is a block diagram showing a relationship between an operation device and an operation sensor in the vehicle control system according to the present embodiment;

FIG. 4 is a block diagram showing a configuration of a drive unit in the vehicle control system according to the present embodiment;

FIG. 5 is a flowchart showing a process when a vehicle is traveling forward in the vehicle control system according to the present embodiment; and

FIG. 6 is a flowchart showing a process when the vehicle is traveling in reverse in the vehicle control system according to the present embodiment.

### DETAILED DESCRIPTION OF EMBODIMENTS

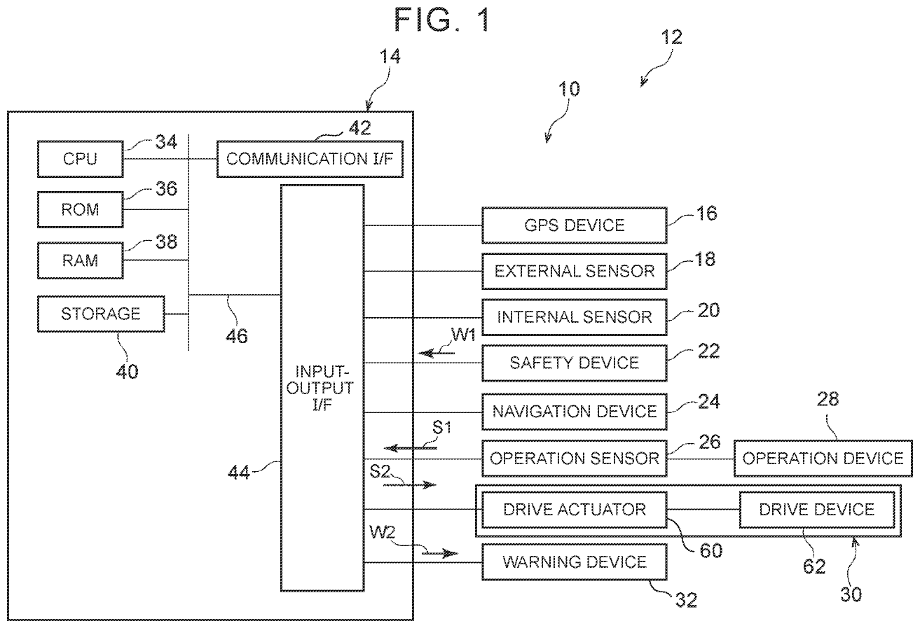

Hereinafter, an example of the embodiment of a “vehicle control system 10” according to the present disclosure will be described with reference to FIGS. 1 to 6. As shown in FIG. 1, the vehicle control system 10 is configured to include a vehicle control device 14, a global positioning system (GPS) device 16, an external sensor 18, an internal sensor 20, a safety device 22, and a “navigation device 24”, an operation sensor 26, an “operation device 28”, a “drive unit 30”, and a “warning device 32” that are mounted in a “vehicle 12”.

First, the configuration of the vehicle control device 14 will be described. The vehicle control device 14 is configured to include a central processing unit (CPU) 34, a read-only memory (ROM) 36, a random access memory (RAM) 38, a storage 40, a communication interface (I/F) 42, and an input-output I/F 44. The CPU 34, the ROM 36, the RAM 38, the storage 40, the communication I/F 42, and the input-output I/F 44 are connected to each other via a bus 46 so as to be able to communicate with each other.

The CPU 34 is a central arithmetic processing unit, and is capable of controlling various devices by executing various programs. Specifically, the CPU 34 is capable of reading the program from the ROM 36 and execute the program using the RAM 38 as a work area. Then, the vehicle control device 14 can exert various functions that will be described later as the execution program stored in the ROM 36 is read out and executed by the CPU 34.

More specifically, the ROM 36 stores various programs and various types of data related to control of the drive unit 30 and the like. Further, the RAM 38 can temporarily store the program or data as a work area.

The storage 40 is configured to include a hard disk drive (HDD) or a solid state drive (SSD), and is capable of storing various programs including an operating system and various types of data such as a standard driving model that will be described later.

The communication I/F 42 is an interface used for connecting the vehicle control device 14 to various networks, and is capable of communicating with a server (not shown) or the like. For the interface above, for example, communication standards such as Ethernet (registered trademark), fiber-distributed data interface (FDDI), and Wi-Fi (registered trademark) are used. Further, the communication I/F 42 may include a wireless device.

The input-output I/F 44 is an interface for the vehicle control device 14 to communicate with various devices mounted on the vehicle 12. Then, the vehicle control device 14 is connected to each of the GPS device 16, the external sensor 18, the internal sensor 20, the safety device 22, the navigation device 24, the operation sensor 26, the operation device 28, the drive unit 30, and the warning device 32 via the input-output I/F 44 so as to be communicable with each other.

The GPS device 16 includes an antenna (not shown) that receives a signal from a GPS satellite, and is capable of measuring the current position of the vehicle 12. Then, the position information of the vehicle 12 measured by the GPS device 16 is input to the storage 40 and temporarily stored in the storage 40.

The external sensor 18 is a group of sensors used for detecting the surrounding environment of the vehicle 12. The external sensor 18 includes, for example, a camera that captures images within a predetermined range, a millimeter-wave radar that transmits an exploration wave to a predetermined range, a laser imaging detection and ranging (LiDAR) that scans a predetermined range, and the like. Then, the data acquired by the external sensor 18 is transmitted to the vehicle control device 14 and temporarily stored in the storage 40.

The internal sensor 20 is a group of sensors used for detecting the traveling state of the vehicle 12, and includes at least one of a vehicle speed sensor, an acceleration sensor, and a yaw rate sensor. Then, the data acquired by the internal sensor 20 is stored in the storage 40.

The safety device 22 is a group of devices for ensuring the safety performance of the vehicle 12, and includes at least one of an antilock brake system (ABS) device, a vehicle stability control (VSC) device, a traction control system (TRC) device, and a pre-crash safety (PCS) device. When the safety device 22 is operated, a predetermined operation signal W1 is output to the vehicle control device 14 such that the operation history of the safety device 22 is stored in the storage 40.

The navigation device 24 includes a display unit (not shown) and a storage unit (not shown). Then, the navigation device 24 is capable of displaying the route to the destination, the current position of the vehicle 12, and the like on the display unit based on the position data of the vehicle 12 acquired by the GPS device 16 and the map data stored in the storage unit. Further, as will be described later, the navigation device 24 is capable of adjusting the display content of the map displayed on the display unit based on the control by the vehicle control device 14.

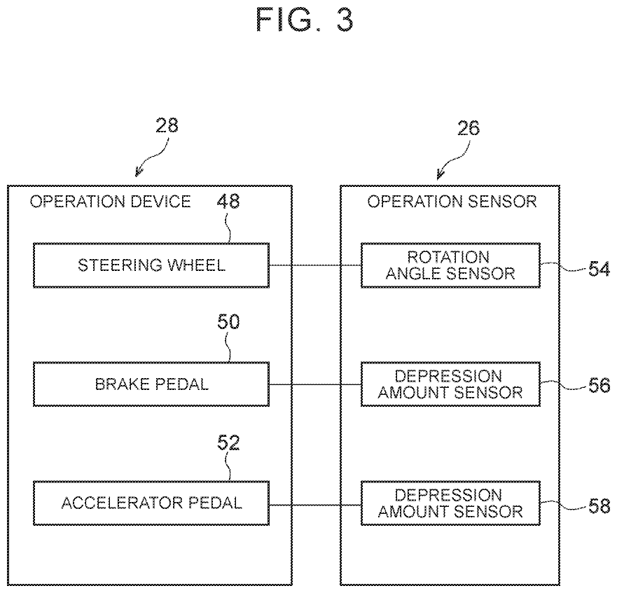

As shown in FIG. 3, the operation device 28 includes a steering wheel 48, a brake pedal 50, and an accelerator pedal 52 operated by a driver (not shown). Then, according to the present embodiment, the driving operation of the operation device 28 by the driver is detected by the operation sensor 26, and an operation signal S1 based on the driving operation is output from the operation sensor 26 to the vehicle control device 14.

Specifically, the operation sensor 26 includes a rotation angle sensor 54, a depression amount sensor 56, and a depression amount sensor 58. The rotation angle sensor 54 is disposed in the vicinity of a rotation shaft (not shown) of the steering wheel 48, and is capable of detecting the angle and the angular velocity when the steering wheel 48 rotates.

The depression amount sensor 56 is disposed in the vicinity of a rotation shaft (not shown) of the brake pedal 50, and is capable of detecting the depression amount of the brake pedal 50. Specifically, the depression amount sensor 56 is capable of detecting the angle and the angular velocity when the brake pedal 50 pivots about the rotation shaft.

The depression amount sensor 58 is disposed in the vicinity of a rotation shaft (not shown) of the accelerator pedal 52, and is capable of detecting the depression amount of the accelerator pedal 52. Specifically, the depression amount sensor 58 is capable of detecting the angle and the angular velocity when the accelerator pedal 52 pivots about the rotation shaft. Then, the vehicle control device 14 is capable of controlling the drive unit 30 by outputting a drive signal S2 to the drive unit 30 based on the operation signal 51 by the operation device 28 described above.

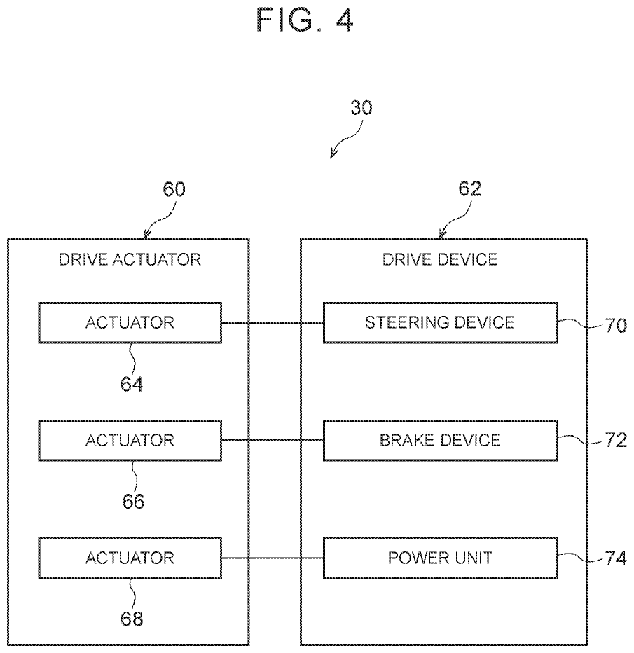

With reference to FIG. 1 again, the drive unit 30 includes a drive actuator 60 and a drive device 62. As shown in FIG. 4, the drive actuator 60 includes a steering actuator 64, a brake actuator 66, and a power unit actuator 68. The drive device 62 includes a steering device 70, a brake device 72, and a “power unit” 74.

Specifically, the steering actuator 64 is configured to include a motor (not shown), drives the steering device 70 based on the drive signal S2, and reflects the operation of the steering wheel 48 by the driver in the steering angle of a steered wheel (not shown) in a normal state.

The brake actuator 66 is configured to include a motor (not shown), drives a brake caliper (not shown) of the brake device 72 based on the drive signal S2, and reflects the operation of the brake pedal 50 by the driver in braking of the vehicle 12 in a normal state.

The power unit actuator 68 is configured to include a motor (not shown), drives a throttle valve (not shown) of the power unit 74 and a drive motor for driving a drive wheel (not shown) based on the drive signal S2, and reflects the operation of the accelerator pedal 52 by the driver in driving of the vehicle 12 in a normal state.

As will be described later, the warning device 32 issues a warning to the driver under predetermined conditions.

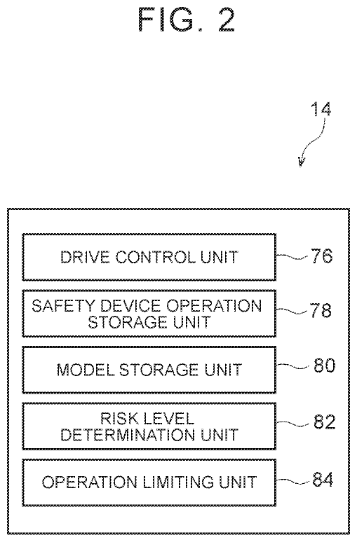

Next, the functional configuration of the vehicle control device 14 will be described with reference to FIG. 2. The vehicle control device 14 reads the execution program stored in the ROM 36 by the CPU 34, and executes the execution program so as to function as an aggregate of a “drive control unit 76”, a safety device operation storage unit 78, a “model storage unit 80”, a “risk level determination unit 82”, and an “operation limiting unit 84”.

The drive control unit 76 is capable of controlling the drive unit 30 by outputting the drive signal S2 based on the operation signal 51 to the drive unit 30 in a normal state. As will be described later, the drive signal S2 is adjusted in accordance with a risk level of the driving operation by the driver.

The safety device operation storage unit 78 is capable of storing the number of times the safety device 22 is operated within a predetermined period based on the operation signal W1 output from the safety device 22.

The model storage unit 80 stores a standard driving model of the vehicle 12. As an example, the standard driving model is a learned neural network model in which a neural network model is learned by deep learning based on collected data related to various operation amounts in each scene when a normative driver drives a vehicle.

Then, the standard driving model is configured to output information (hereinafter referred to as a normative driving operation) indicating the driving operation by the normative driver when data representing a certain scene (for example, the radius of curvature of a road on which the vehicle 12 is traveling, the vehicle speed of the vehicle 12, and the distance to the preceding vehicle) is input. Note that, the normative driver herein means, for example, a good driver who has not committed a traffic violation within the past five years and whose average driving time is three hours or more per day. In addition, the number of normative drivers from whom data is collected may be singular or plural.

The risk level determination unit 82 compares the driving operation of the vehicle 12 by the driver based on the operation signal S1 input from the operation device 28 with the normative driving operation output from the standard driving model, and determines the risk level of the driving operation. The risk level referred herein is an index indicating the risk level of the driving operation by the driver, and is a value indicating the degree of deviation between the driving operation by the driver and the normative driving operation.

Specifically, when the radius of curvature of the road on which the vehicle 12 is traveling acquired by the external sensor 18, the vehicle speed of the vehicle 12 acquired by the internal sensor 20, and the like are input to the standard driving model, the normative driving operation when the vehicle is traveling on a curve is output from the standard driving model. Then, the risk level determination unit 82 determines the curve traveling risk level in accordance with the degree of deviation of the driving operation by the driver from the normative driving operation.

Further, the risk level determination unit 82 compares the speed of the vehicle 12 with the legal speed stored in the navigation device 24 or the like, and determines a driving speed risk level depending on the degree of deviation between the speed of the vehicle 12 and the legal speed.

Further, the risk level determination unit 82 determines a reverse driving risk level in accordance with the number of times that the driving operation by the driver deviates from the normative driving operation output from the standard driving model when the vehicle 12 is traveling in reverse.

Specifically, during reverse traveling of the vehicle 12, when the road on which the vehicle 12 is traveling and the situation around the vehicle 12 acquired by the external sensor 18 or the like are input to the standard driving model, the normative driving operation for reverse traveling is output from the standard driving model. Then, the risk level determination unit 82 measures the number of times that the driving operation by the driver deviates from the normative driving operation within a predetermined time when the vehicle 12 is traveling in reverse, and determines the reverse driving risk level based on the number of times.

Further, the risk level determination unit 82 outputs an operation signal W2 to the warning device 32 when the reverse driving risk level reaches a predetermined risk level when the vehicle 12 is traveling in reverse. Then, when the operation signal W2 is input from the risk level determination unit 82, the warning device 32 issues a warning to the driver for a predetermined time to notify that the driver is engaging in the risky driving.

Further, the risk level determination unit 82 determines a narrow road driving risk level of the driving operation by the driver on the narrow road. Specifically, the risk level determination unit 82 is capable of determining whether the vehicle 12 is traveling on a road narrower than the narrow road, that is, the predetermined road width, based on the road on which the vehicle 12 is traveling, the situation around the vehicle 12, and the like acquired by the external sensor 18 or the like.

On the other hand, when the road on which the vehicle 12 is traveling, the situation around the vehicle 12, the road width of the road, and the like are input, the standard driving model outputs the normative driving operation corresponding to the road width. Then, when the risk level determination unit 82 determines that the vehicle 12 is traveling on a narrow road, the risk level determination unit 82 determines the narrow road driving risk level in accordance with the degree of deviation between the driving operation by the driver and the normative driving operation.

Further, the risk level determination unit 82 is capable of limiting the display of the narrow road by the navigation device 24 in accordance with the narrow road driving risk level. Specifically, the risk level determination unit 82 controls the navigation device 24 based on the narrow road driving risk level such that the display unit of the navigation device 24 does not display a road with a road width narrower than the predetermined road width.

In addition, the risk level determination unit 82 determines the risk level of the driving operation based on the number of operations of the safety device 22 stored in the safety device operation storage unit 78. Further, the risk level determination unit 82 determines whether there is a traffic violation, that is, the degree of legal compliance, based on the data acquired by the external sensor 18 and the driving operation of the vehicle 12 by the driver based on the operation signal 51, and also determines the risk level of the driving operation based on the degree of legal compliance.

The operation limiting unit 84 is capable of adjusting the drive signal S2 output to the drive unit 30 based on the determination of the risk level by the risk level determination unit 82. Then, the operation limiting unit 84 is capable of limiting driving of the drive unit 30 by inputting the adjusted drive signal S2 to the drive unit 30.

Specifically, the operation limiting unit 84 is capable of setting the speed limit of the vehicle 12 in accordance with the driving speed risk level determined by the risk level determination unit 82. Then, in the present embodiment, the drive unit 30 is controlled by the operation limiting unit 84 such that the power unit 74 is driven in accordance with the depression amount of the accelerator pedal 52 until the speed of the vehicle 12 reaches the speed limit.

On the other hand, when the speed of the vehicle 12 has reached the speed limit, the operation limiting unit 84 controls the drive unit 30 to control the drive amount of the power unit 74 such that the speed of the vehicle 12 does not exceed the speed limit even when the depression amount of the accelerator pedal 52 increases. When the speed of the vehicle 12 do not deviate from the legal speed, the speed limit of the vehicle 12 is set to the legal speed.

Further, the operation limiting unit 84 limits the drive amount of the power unit 74 when the vehicle 12 is traveling in reverse in accordance with the reverse driving risk level determined by the risk level determination unit 82. As an example, the operation limiting unit 84 sets the speed limit in accordance with the reverse driving risk level determined by the risk level determination unit 82 when the vehicle 12 is traveling in reverse to control the drive amount of the power unit 74 such that the speed of the vehicle 12 does not exceed the speed limit.

In addition, the operation limiting unit 84 is capable of limiting traveling of the vehicle 12 on the narrow road in accordance with the narrow road driving risk level determined by the risk level determination unit 82. Specifically, even when the driver tries to drive the vehicle 12 toward a narrow road, the operation limiting unit 84 controls the drive unit 30 such that steering or the like based on the operation signal 51 is not performed.

### Operation and Effects of Embodiment

Next, the operations and effects of the present embodiment will be described.

In the present embodiment, as shown in FIGS. 1 and 2, when the driver operates the operation device 28, the operation signal S1 based on the driving operation is input to the drive control unit 76 that drives the drive unit 30 of the vehicle 12, whereby the drive unit 30 is controlled.

When the driver engages in the risky driving, it is not desirable that the driving operation by the driver be directly reflected in traveling of the vehicle 12. In this regard, it is conceivable to adopt a system that issues a warning to the driver by reducing occupant comfort of the vehicle 12 or restricting the start-up of the engine when the driver engages in the risky driving. However, in such a system, the functions irrelevant to traveling of the vehicle 12 are impaired, and the system cannot be directly involved in driving of the vehicle 12. Therefore, in terms of ensuring the traveling safety of the vehicle 12, it is conceivable that the system does not work well.

Here, in the present embodiment, the standard driving model of the vehicle 12 is stored in the model storage unit 80. The risk level determination unit 82 compares the driving operation by the driver with the normative driving operation output from the standard driving model and determines the risk level of the driving operation. Then, the operation limiting unit 84 inputs, to the drive unit 30, the drive signal S2 adjusted based on the determination by the risk level determination unit 82 on the risk level of the driving operation by the driver so as to limit driving of the drive unit 30.

Therefore, in the present embodiment, when the driver engages in the risky driving, it is possible to limit that the driving operation by the driver is directly reflected in traveling of the vehicle 12. Therefore, in the present embodiment, it is possible to suppress the driver from engaging in the risky driving by direct involvement in driving of the vehicle 12.

Further, in the present embodiment, the power unit 74 of the vehicle 12 is controlled by inputting the operation signal S1 based on the operation of the accelerator pedal 52 by the driver to the drive control unit 76.

When the driver tends to drive the vehicle 12 in excess of the legal speed, it is not desirable that the operation of the accelerator pedal 52 by the driver be directly reflected in driving of the power unit 74 of the vehicle 12.

Here, in the present embodiment, the risk level determination unit 82 determines the driving speed risk level by comparing the speed of the vehicle 12 with the legal speed. Then, the operation limiting unit 84 sets the speed limit of the vehicle 12 in accordance with the driving speed risk level. When the speed of the vehicle 12 is a speed up to the speed limit, the operation limiting unit 84 drives the power unit 74 in accordance with the depression amount of the accelerator pedal 52.

On the other hand, in a state where the speed of the vehicle 12 is the speed limit, the operation limiting unit 84 controls the drive amount of the power unit 74 such that the speed of the vehicle 12 does not exceed the speed limit even when the depression amount of the accelerator pedal 52 increases.

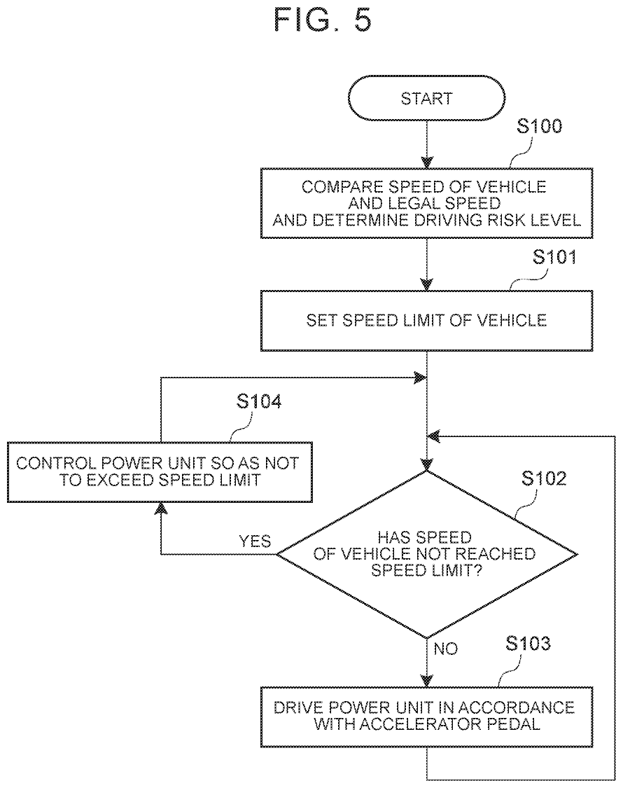

Hereinafter, a control flow executed by the vehicle control device 14 during forward traveling of the vehicle 12 will be described with reference to the flowchart shown in FIG. 5.

This control flow is started when the CPU 34 of the vehicle control device 14 receives a predetermined control signal.

When the control flow is started, in step S100, the CPU 34 functions as the risk level determination unit 82, and determines the driving speed risk level by comparing the speed of the vehicle 12 with the legal speed. The process then proceeds to step S101.

In step S101, the CPU 34 functions as the operation limiting unit 84, and sets the speed limit of the vehicle 12 in accordance with the driving speed risk level. The process then proceeds to step S102.

In step S102, the CPU 34 functions as the operation limiting unit 84, and determines whether the speed of the vehicle 12 has reached the speed limit. Then, when the CPU 34 determines that the speed of the vehicle 12 has not reached the speed limit (step S102: NO), the process proceeds to step S103. On the other hand, when the CPU 34 determines that the speed of the vehicle 12 has reached the speed limit (step S102: YES), the process proceeds to step S104.

In step S103, the CPU 34 functions as the operation limiting unit 84, and drives the power unit 74 in accordance with the depression amount of the accelerator pedal 52 until the speed of the vehicle 12 reaches the speed limit. The process then returns to step S102.

In step S104, the CPU 34 functions as the operation limiting unit 84, and controls the drive amount of the power unit 74 such that the speed of the vehicle 12 does not exceed the speed limit even when the depression amount of the accelerator pedal 52 increases. The process then returns to step S102. Note that the control flow ends when the CPU 34 receives a predetermined control signal when the power unit 74 of the vehicle 12 stops.

As described above, according to the present embodiment, the speed of the vehicle 12 can be limited when the driver tends to drive the vehicle 12 in excess of the legal speed. Therefore, according to the present embodiment, it is possible to limit unnecessary acceleration by the driving operation by the driver

Further, according to the present embodiment, the risk level determination unit 82 determines a reverse driving risk level in accordance with the number of times that the driving operation by the driver deviates from the normative driving operation output from the standard driving model when the vehicle 12 is traveling in reverse. Then, the operation limiting unit 84 limits the drive amount of the power unit 74 in accordance with the reverse driving risk level when the vehicle 12 is traveling in reverse.

Further, according to the present embodiment, the warning device 32 issues a warning to the driver when the reverse driving risk level determined by the risk level determination unit 82 reaches a predetermined risk level.

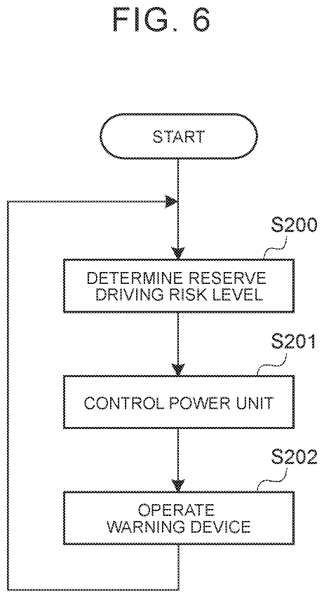

Hereinafter, a control flow executed by the vehicle control device 14 during reverse traveling of the vehicle 12 will be described with reference to the flowchart shown in FIG. 6.

This control flow is started when the CPU 34 of the vehicle control device 14 receives a predetermined control signal at predetermined time intervals.

When the control flow is started, in step S200, the CPU 34 functions as the risk level determination unit. Then, the CPU 34 measures the number of times that the driving operation by the driver deviates from the normative driving operation output from the standard driving model within a predetermined time during reverse traveling of the vehicle 12, and determines the reverse driving risk level based on the number of times. The process then proceeds to step S201.

In step S201, the CPU 34 functions as the operation limiting unit 84, and controls the drive amount of the power unit 74 in accordance with the reverse driving risk level such that the speed of the vehicle 12 does not exceed the speed limit. The process returns to step S202.

In step S202, the CPU 34 functions as the risk level determination unit 82, and operates the warning device 32 for a predetermined time when the reverse driving risk level reaches a predetermined risk level. The process then returns to step S200. Note that the control flow ends as the CPU 34 receives a predetermined control signal when the reverse operation of the vehicle 12 ends.

As described above, according to the present embodiment, when the driver who tends to perform the driving operation that deviates from the normative driving operation output from the standard driving model when the vehicle 12 is traveling in reverse performs the driving operation to cause the vehicle 12 to travel in reverse, unnecessary acceleration of the vehicle 12 can be limited. Therefore, according to the present embodiment, it is possible to reduce an influence of the erroneous operation by the driver when the vehicle 12 is traveling in reverse.

Further, according to the present embodiment, the driver can be made to recognize that the driving operation by the driver when the vehicle 12 is traveling in reverse deviates from the normative driving operation output from the standard driving model and encourage the driver to improve the driving operation when the vehicle 12 is traveling in reverse. Therefore, according to the present embodiment, the influence of the erroneous operation by the driver can be further reduced when the vehicle 12 is traveling in reverse.

With reference to FIG. 2 again, according to the present embodiment, the risk level determination unit 82 compares the driving operation by the driver with the normative driving operation output from standard driving model and determines the narrow road driving risk level of the driving operation on a narrow road. Then, the operation limiting unit 84 limits traveling of the vehicle 12 on the narrow road in accordance with the narrow road driving risk level. Therefore, according to the present embodiment, it is possible to limit entry of the vehicle 12 to a road that is difficult for the driver to drive with the driving skill of the driver. Accordingly, according to the present embodiment, the driver can travel on a road having a road width corresponding to the driving skill of the driver.

Further, as shown in FIG. 1, according to the present embodiment, the risk level determination unit 82 limits display of narrow roads by the navigation device 24 in accordance with the narrow road driving risk level. Therefore, it is possible to suppress setting of a narrow road that is difficult for the driver to drive with the driving skill of the driver in the directions to the destination guided by the navigation device 24. Therefore, according to the present embodiment, it is possible to enhance the accuracy with which the driver travels on a road having a road width corresponding to the driving skill of the driver.

### Supplementary Explanation of Above Embodiment

(1) According to the above-described embodiment, the learned neural network model in which the neural network model is learned by deep learning is adopted as the standard driving model. However, the present disclosure is not limited to this. For example, a standard operation table in which information on each scene when the vehicle is traveling (for example, the radius of curvature of the road on which the vehicle is traveling and the vehicle speed of the vehicle) and the driving operations of the normative driver in each scene are associated may be adopted as the standard driving model, depending on the specifications of the vehicle 12 and the like.

(2) Further, according to the above-described embodiment, the drive unit 30 that is the operation target of the operation device 28 includes the steering device 70, the brake device 72, and the power unit 74. However, the present disclosure is not limited to this. For example, the drive unit 30 may include a transmission, or the operation device 28 may include an operation device for the transmission, depending on the specifications of the vehicle 12 and the like.

What is claimed is:

1. A vehicle control system comprising:
an operation device that is able to control a drive unit of a vehicle by inputting an operation signal based on a driving operation of a driver to a drive control unit that drives the drive unit;
a model storage unit that stores a standard driving model of the vehicle;
a risk level determination unit that compares the driving operation with the standard driving model and determines a risk level of the driving operation; and
an operation limiting unit that is able to limit driving of the drive unit by inputting a drive signal to the drive unit, the drive signal being adjusted based on the determination on the risk level by the risk level determination unit.

2. The vehicle control system according to claim 1, wherein:
the operation device includes an accelerator pedal;
the drive unit includes a power unit;
the risk level determination unit determines a driving speed risk level by comparing a speed of the vehicle with a legal speed; and
the operation limiting unit sets a speed limit of the vehicle in accordance with the driving speed risk level and drives the power unit up to the speed limit in accordance with a depression amount of the accelerator pedal, and controls a drive amount of the power unit at the speed limit such that the speed of the vehicle does not exceed the speed limit even when the depression amount increases.

3. The vehicle control system according to claim 2, wherein:
the risk level determination unit determines a reverse driving risk level in accordance with the number of times that the driving operation deviates from the standard driving model when the vehicle is traveling in reverse; and
the operation limiting unit limits the drive amount of the power unit in accordance with the reverse driving risk level when the vehicle is traveling in reverse.

4. The vehicle control system according to claim 3, further comprising a warning device that issues a warning to the driver when the reverse driving risk level reaches a predetermined risk level.

5. The vehicle control system according to claim 1, wherein:
the risk level determination unit determines a narrow road driving risk level of the driving operation on a narrow road; and
the operation limiting unit limits traveling of the vehicle on the narrow road in accordance with the narrow road driving risk level.

6. The vehicle control system according to claim 5, wherein:
the vehicle is equipped with a navigation device that is able to guide directions to a destination; and
the risk level determination unit is able to limit display of the narrow road by the navigation device in accordance with the narrow road driving risk level.
